(19) United States
(12) Patent Application Publication
(10) Pub. No.: US 2011/0056131 A1
(43) Pub. Date: Mar. 10, 2011

(54) Self-orientating plant pot and tray system

(76) Inventors: Thomas J. Smith, Carleton, MI (US); Henry L. Huntington, Loudon, NH (US)

(21) Appl. No.: 12/806,745

(22) Filed: Aug. 19, 2010

Related U.S. Application Data
(63) Continuation-in-part of application No. 12/148,348, filed on Apr. 18, 2008.

(51) Int. Cl. A01G 9/02; G09F 3/00

(52) U.S. Cl. 47/86; 40/299.01

(57) ABSTRACT

A self-orientating plant pot and tray system is provided. The pot includes a top and/or a body and is provided with a first drain opening. The top has a first substantially elliptical cross-section and/or the body has a first tapering substantially elliptical cross-section. The tray defines at least one receiving area each for securingly receiving a plant pot in a desired orientation relative therewith. The receiving area includes an upper chamber and/or a body chamber, which are each respectively defined by a depression and/or a receptacle. The depression has a second substantially elliptical cross-section for mating with the top and/or the receptacle has a second tapering substantially elliptical cross-section for mating with the body. The receptacle can be provided with a second drain opening for fluid communication with the first drain opening. The pots can include indicia facing substantially the same direction when assembled with the tray.

### CROSS-REFERENCE TO RELATED APPLICATIONS

The present application is a continuation-in-part of, and claims the benefit of priority to, U.S. patent application Ser. No. 12/148,348, filed Apr. 18, 2008, the contents of which are incorporated by reference herein for all purposes.

### FIELD OF THE INVENTION

The present invention relates generally to plant pots and trays, and, more particularly, to a plant pot and tray system for positioning plant pots in a desired orientation.

### BACKGROUND OF THE INVENTION

It is common for a plant pot to be provided with a plant tag to identify the plant in the pot. The tag may be positioned in the soil in the pot or in a slot in the pot such that the plant pot, when rotated between various orientations, would provide different views of the plant tag at different angles. While having a choice of multiple views can be advantageous, it is not uncommon for a plant pot to be displayed in a desired orientation at the point-of-sale, such that the tags are facing in the same direction and easily viewed. However, the desired orientation of the plant pot is vulnerable to altercations, such as when a customer at the point-of-sale inadvertently “bumps” into the plant pot or when the pot is placed in the tray at an angle. What is needed in the art is a plant pot and tray system that overcomes these and other disadvantages and shortcomings of the prior art.

### SUMMARY OF THE INVENTION

The present invention overcomes the disadvantages and shortcomings of the prior art by providing a self-orientating plant pot and tray system in which an interference fit is provided for inhibiting rotation of a plant pot when positioned in a tray therefor.

In a first aspect, the self-orientating plant pot and tray system includes a plant pot that has a drain opening and a top with a first substantially elliptical cross-section. A tray is also provided, which has a receiving area for securingly receiving the plant pot into a desired orientation. The receiving area includes a depression having a chamber of a second substantially elliptical cross-section that corresponds to the first substantially elliptical cross-section, such that the depression is configured to mate with the top of the pot to inhibit rotation of the plant pot.

In a second aspect, the self-orientating plant pot and tray system additionally or alternatively has a first tapering substantially elliptical cross-section. A tray is provided with the receiving area, which can include a receptacle defining a chamber of a second tapering substantially elliptical cross-section that corresponds to the first tapering substantially elliptical cross-section, such that the receptacle is configured to mate with a body of the plant pot to inhibit rotation thereof.

As shown and herein discussed, however, it is contemplated that a self-orientating system can be provided with both aspects, e.g., with a mating top and depression, as well as with a mating body and receptacle. Additional features, functions and benefits of the disclosed self-orientating plant pot and tray system will be apparent from the detailed description which follows, particularly when read in conjunction with the accompanying figures.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a perspective exploded view showing a self-orientating plant pot and tray system constructed in accordance with a first embodiment of the present invention, said plant pot and tray system being shown to include a plurality of plant pots and a tray having a plurality of receiving areas for the plant pots;

FIG. 2 is a perspective assembly view of the plant pot and tray system of FIG. 1;

FIG. 3 is a top plan view of the plant pot and tray system of FIGS. 1-2;

FIG. 4 is a bottom plan view of the plant pot and tray system of FIGS. 1-3;

FIG. 5 is a front elevational view of the plant pot and tray system of FIGS. 1-4;

FIG. 6 is a left side elevational view of the plant pot and tray system of FIGS. 1-5;

FIG. 7 is a top plan view of the tray of FIGS. 1-6;

FIG. 8 is a bottom plan view of the tray of FIGS. 1-7;

FIG. 9 is a front elevational view of one of the plurality of plant pots of FIGS. 1-6, a rear elevational view being identical thereto;

FIG. 10 is a left side elevational view of the one of the plurality of plant pots of FIG. 9, a right side elevational view being identical thereto;

FIG. 11 is a top plan view of the one of the plurality of plant pots of FIGS. 1-6 and 9-10;

FIG. 12A is a cross-sectional view showing one of the plurality of receiving areas mating with one of the plurality of plant pots, the cross-section having been taken along section line 12A-12A of FIG. 3;

FIG. 12B is a cross-sectional view similar to FIG. 12A, but with the plant pot having been omitted;

FIG. 13 is a cross-sectional view showing a depression of one of the plurality of receiving areas mating with a top of one of the plurality of plant pots, the cross-section having been taken along section line 13-13 of FIG. 5;

FIG. 14 is a cross-sectional view showing a receptacle of one of the plurality of receiving areas mating with a pot body of one of the plurality of plant pots, the cross-section having been taken along section line 14-14 of FIG. 5;

FIG. 15 is another cross-sectional view showing the receptacle mating with the pot body, the cross-section having been taken along section line 15-15 of FIG. 5;

FIG. 16 is a perspective view showing a plant pot and tray system constructed in accordance with a second embodiment of the present invention;

FIG. 17 is a perspective view showing a plant pot and tray system constructed in accordance with a third embodiment of the present invention;

FIG. 18 is a front perspective exploded view showing a plant pot and tray system constructed in accordance with another embodiment of the present invention, a rear perspective exploded view of the system of FIG. 18 being substantially identical thereto; and

FIG. 19 is a front perspective assembly view of the system of FIG. 18, a rear perspective assembly view of the system of FIG. 19 being substantially identical thereto.

### DETAILED DESCRIPTION OF THE EXEMPLARY EMBODIMENTS

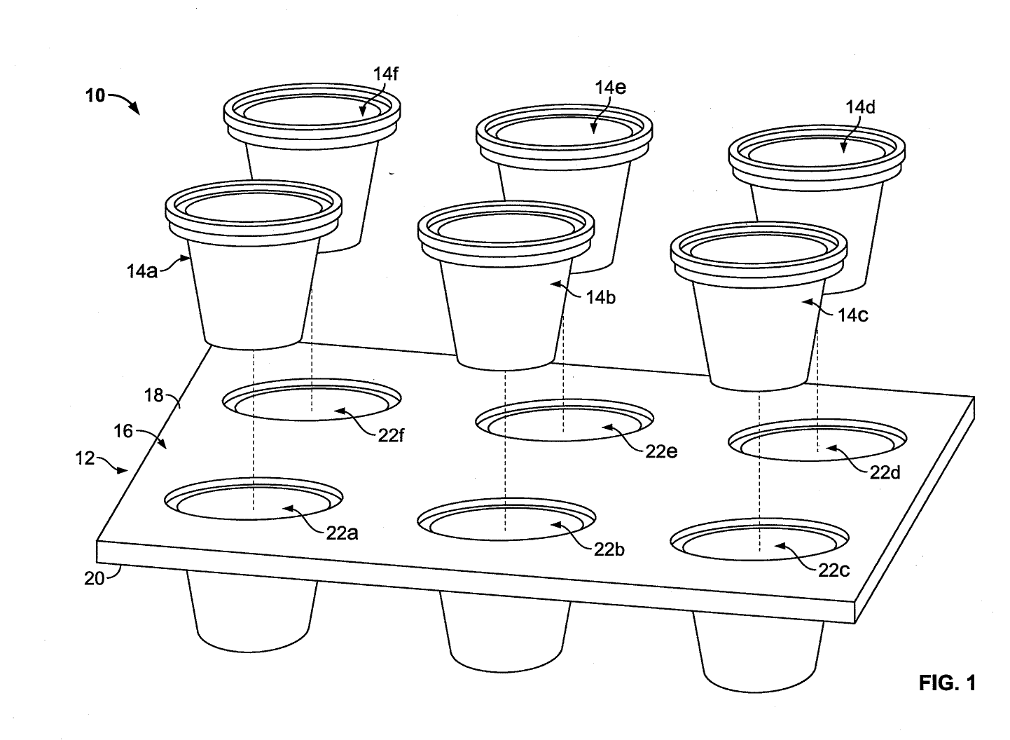

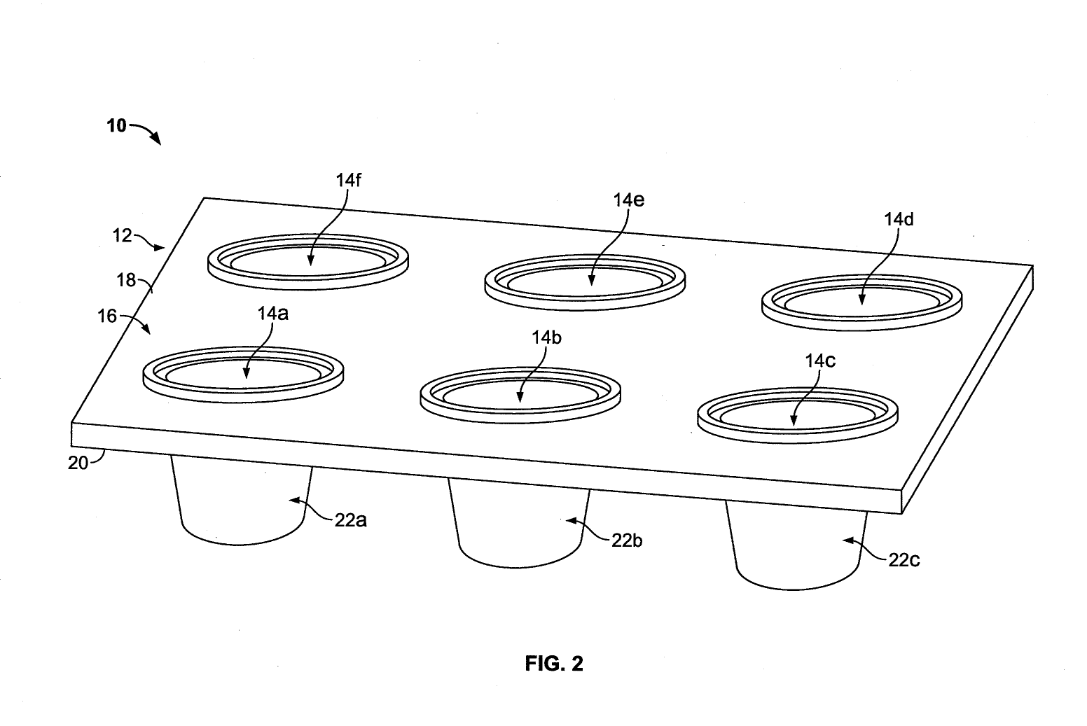

Referring to FIGS. 1-6, a self-orientating plant pot and tray system 10 is shown constructed in accordance with a first embodiment of the invention. The self-orientating system 10 includes a tray 12 and a plurality of plant pots 14a-f received by the tray 12. Each of the tray 12 and the plant pots 14a-f shall be discussed below in further detail.

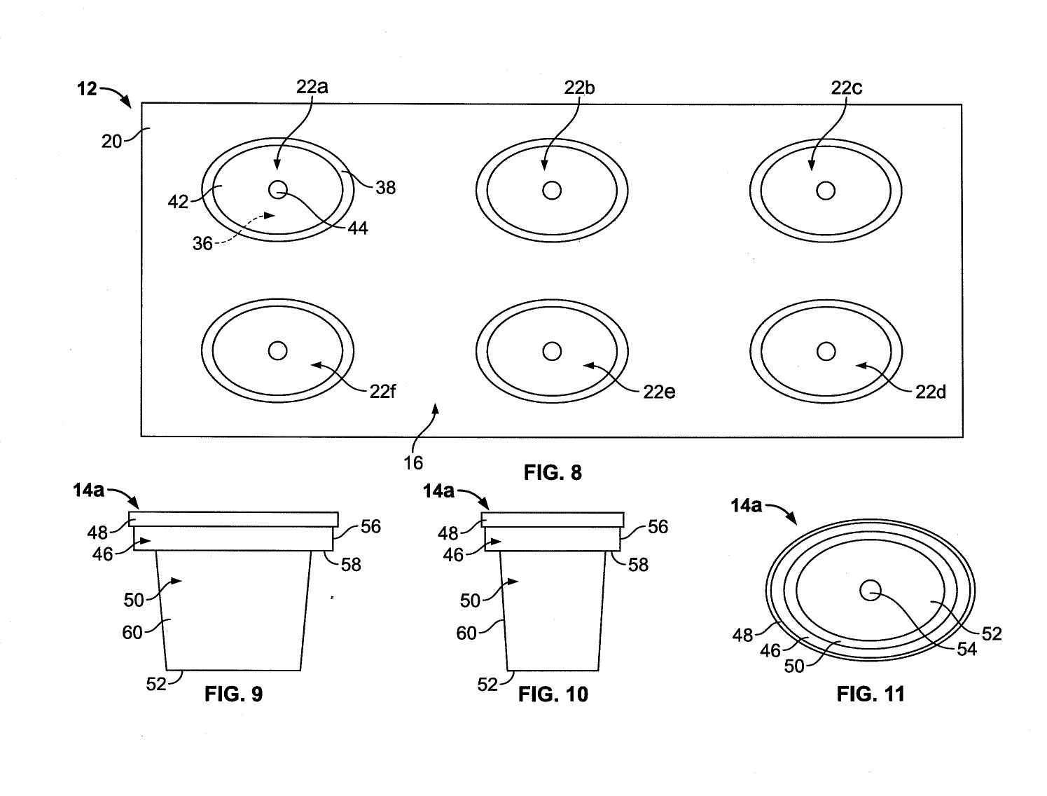

Referring to FIGS. 1-8, the tray 12 is formed of any material suitable for securingly receiving the plant pots 14a-f as herein described, such as polyvinyl chloride (PVC) and/or another plastic or polymer such as those commonly used to make planting pots and trays therefore. As the tray 12 may be rested upon an environmental surface, such as shelf, the material is preferably of a strength to provide structural support to the self-orientating system 10.

The tray 12 includes a tray body 16 having a first tray side 18 and a second tray side 20 generally opposite thereto. The shape, dimensions, etc. of the tray body 16 can be selected in accordance with aesthetic considefrations. In this regard, design of the tray body 16 can include, for example, a generally rectangular shape where the first and second sides 18, 20 are each generally planar and parallel to the other.

The tray 16 further includes a plurality of receiving areas 22a-f for securingly receiving one of the plant pots 14a-f into to a desired orientation, such as by virtue of a downward gravitational force and an interference fit between one of the plant pots 14a-f and a corresponding one of the receiving areas 22a-f. It shall be understood that the tray 12 can include any suitable number of receiving areas 22a-f selected in accordance with aesthetic considerations, and that the position along the tray body 16 of one of the receiving areas 22a-f relative to another one of the receiving areas 22a-f can also be selected in accordance with aesthetic considerations. An exemplary discussion of the receiving area 22a of the tray 12 shall now be provided with further detail, though it shall be understood that such discussion is equally applicable to the receiving areas 22b-f.

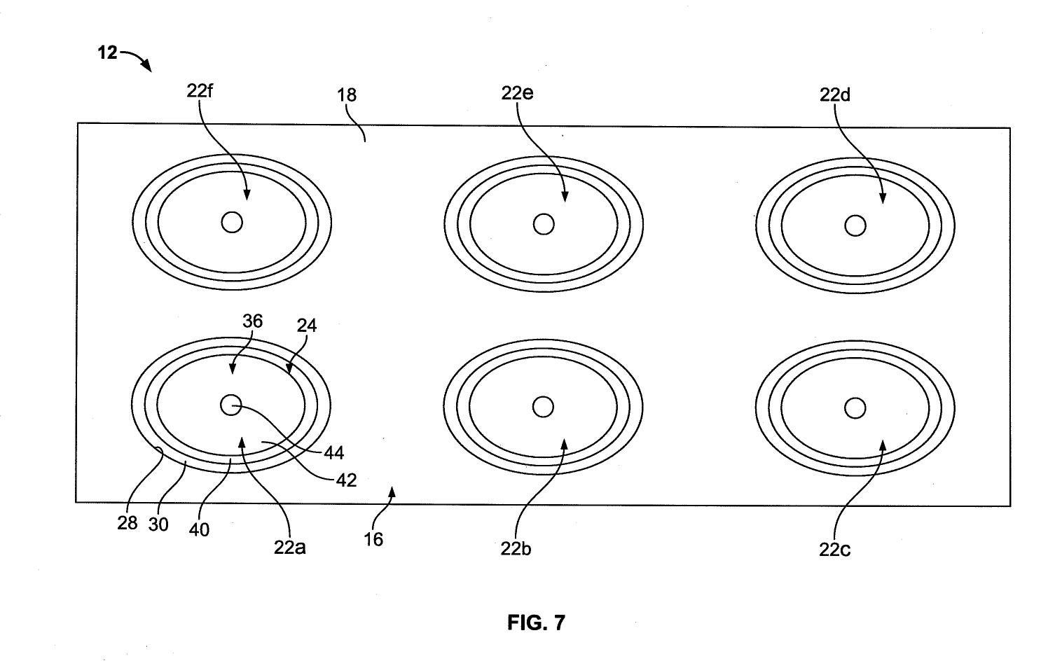

Referring to FIGS. 7-8 and 15, the receiving area 22a is shown to include both a depression 24 and a receptacle 26, each for mating with the pot 14a. It is contemplated, however, that the receiving area 22a can include the depression 24 and/or the receptacle 26. Each of the depression 24 and the receptacle 26 shall be discussed below in turn. The receiving area 22a is preferably orientated about a central axis Aᵣₐ.

The depression 24 includes a substantially elliptical wall 28 extending from the first tray side 18 toward the second tray side 20 and further includes a substantially elliptical ledge 30 spaced apart from the first tray side 18 by the substantially elliptical wall 28. The substantially elliptical wall 28 and the substantially elliptical ledge 30 define in the depression 24 of the receiving area 22a a chamber, which is referenced herein as an upper chamber 32, and which will be discussed further below in connection with the plant pot 14a. The depression 24 has a substantially elliptical cross-section. Such substantially elliptical cross-section is preferably continuous along at least a part of an elevation E_{D} of the depression 24 of the receiving area 22a, and, more preferably, along the entirety of the elevation E_{D} of the depression 24 of the receiving area 22a.

The receptacle 26 includes a sidewall 34 and chamber defined thereby, which is referenced herein as a body chamber 36, and which will be discussed further below in connection with the plant pot 14a. As shown, the sidewall 34 includes an outer surface 38 extending from the second tray side 20 and an inner surface 40 extending from the substantially elliptical ledge 30, such that the receptacle 26 can be characterized as being a substantially hollow “leg” of the tray 12. Embodiments of the invention are contemplated where the inner surface 40 of the receptacle 26a can extend directly from the first tray side 18.

Referring to FIG. 14, the receptacle 26, the sidewall 34, the body chamber 36, etc. can be provided with a substantially elliptical cross-section. The substantially elliptical cross-section is preferably continuous along at least a part of an elevation E_{R} of the receptacle 26 of the receiving area 22a, and, more preferably, along the entirety of the elevation E_{R} of the receptacle 26 of the receiving area 22a.

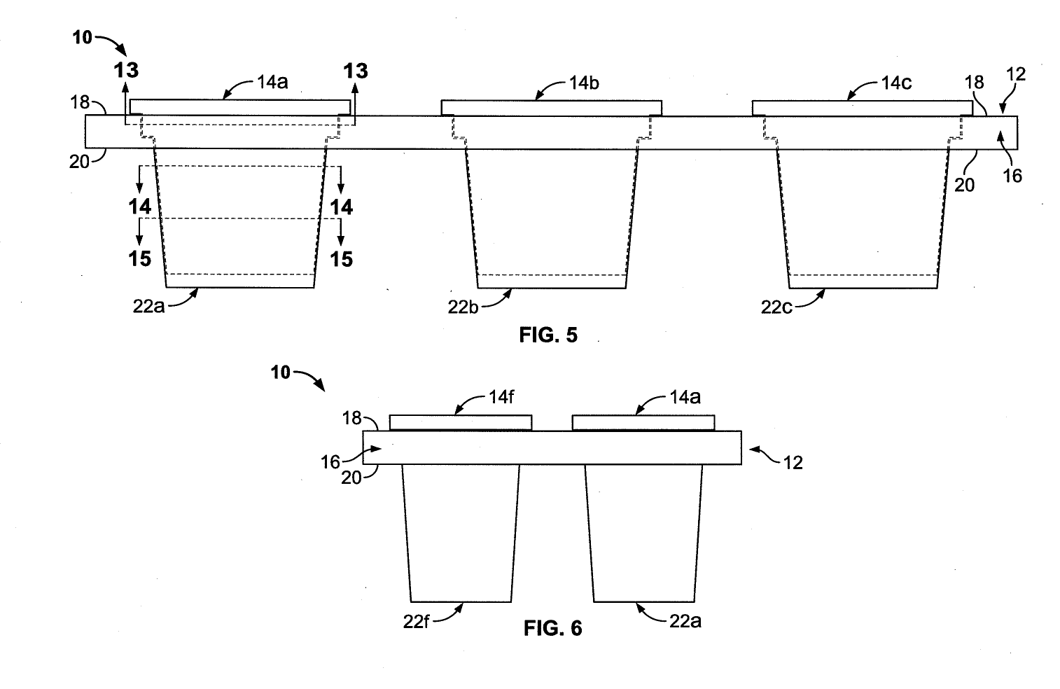

More particularly, and referring to FIGS. 14 and 15, the substantially elliptical cross-section of the receptacle 26, the sidewall 34, the body chamber 36, etc. preferably comprise a tapering substantially elliptical cross-section. For example, the cross-section along section line 14-14 of FIG. 5 (FIG. 14) is of a first area REC₁ and the cross-section along section line 15-15 of FIG. 5 (FIG. 15) is of a second area REC₂ less than the first area REC₁. The tapering substantially elliptical cross-section is preferably continuous along at least a part of the elevation E_{R} of the receptacle 26 of the receiving area 22a, and, more preferably, along the entirety of the elevation E_{R} of the receptacle 26 of the receiving area 22a. In this regard, the receptacle 26 preferably has the shape of a conventional frustum, but with a tapering substantially elliptical cross-section along an elevation thereof. As shown, the receptacle 26 is tapered in a direction opposite the tray body 16.

An advantage of the substantially elliptical cross-section(s) of the receptacle 26 is that such cross-section is non-circular (at least in part) and thus inhibits rotation of the plant pot 14a about the axis A_{RA} when received into the receiving area. In this regard, the term “substantially elliptical cross-section” should be construed as including a cross-section having any suitable shape, so long as such shape comprises, consists, and/or consists essentially of curves not substantially forming a circle. Naturally, the absence of a circular perimeter is not required at all elevations along the receiving area 22a, because some absence only of a circular perimeter about the axis A_{RA} would effect the purpose of inhibiting rotation about the axis A_{RA}. Notwithstanding, it is contemplated that a cross-section having a perimeter consisting essentially of curves not forming a circle can extend continuously along the elevation E_{L}, for example, and that such perimeter can be continuously tapered along the elevation E_{L}, for example.

The receptacle 26 is provided with a tray bottom surface 42 configured to support the tray 12 when rested upon an environmental structure. As shown, the tray bottom surface 42 is provided as a substantially-elliptical end wall extending inwardly from the sidewall 34. The tray bottom surface 42 is preferably provided with an opening extending therethrough, which is referenced herein as a tray drain opening 44.

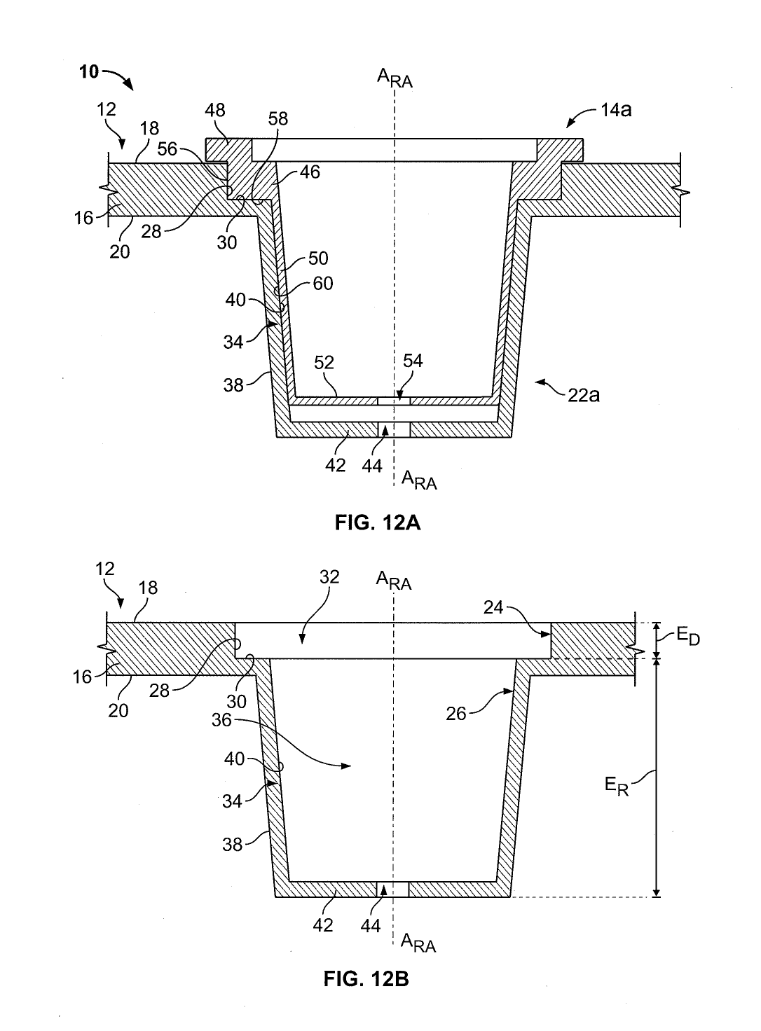

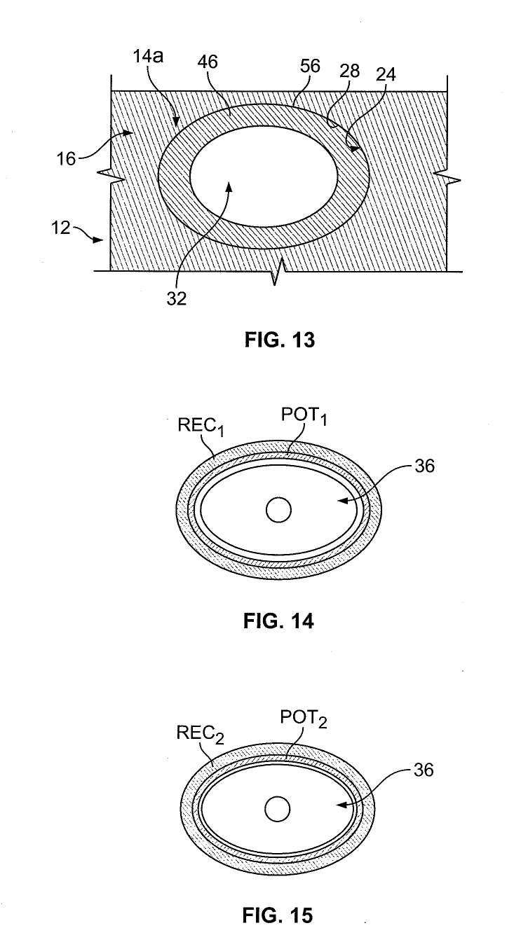

Referring to FIGS. 1-6 and 9-15, the self-orientating system 10 includes the plurality of plant pots 14a-f. An exemplary discussion of the plant pot 14a shall now be provided with further detail, though it shall be understood that such discussion is equally applicable to the plant pots 14b-f. Furthermore, while exemplary discussion is further provided below with regards to the interaction and relationships between the plant pot 14a and the receiving area 22a, it shall be understood that such discussion is equally applicable with regards to the respective interactions and relationships between the plant pots 14b-f and the receiving areas 22b-f corresponding thereto. It shall be further understood that the present invention is not limited to a self-orientating system having each one of the plant pots thereof identical to each other one of the plant pots thereof.

Continuing with reference to FIGS. 1-6 and 9-15, the plant pot 14a is provided with a top 46, a flange 48 extending outwardly from a first end of said top 48 (not designated), and a pot body 50 extending from a second end of said top 46 opposite said first end (not designated). The plant pot 14a defines a chamber therein (not designated), which is configured to receive soil, plants, flowers, etc. The plant pot 14a can include a pot bottom wall 52 extending inwardly from an end of said pot body 50 opposite said top 46, and a drain opening 54 is defined in the plant pot 14a, preferably through the pot bottom wall 52 in communication with the chamber within the plant pot 14a.

The top 46 includes an outer surface, which is referenced herein as a top outer surface 56, and a bottom surface, which is referenced herein as a top lower surface 58. The top 46 preferably has a substantially elliptical cross-section, and, in this regard, each of the top outer surface 56 and the top lower surface 58 preferably has a substantially elliptical shape, e.g., at least a substantially elliptical perimeter. Such substantially elliptical cross-section is preferably continuous along at least a part of an elevation (not designated) of the top 46, and, more preferably, along an entire elevation (not designated) of the top 46. The cross-section of the top 46 preferably corresponds to the cross-section of the depression 24, such that the top 46 is configured to mate with the depression 24 by being received into the upper chamber 32. In use, e.g., when the self-orientating system 10 is provided in assembled form, the top 46 mates with the upper chamber 32. The downward gravitational force seats the top lower surface 58 upon the substantially elliptical ledge 30. Moreover, the top outer surface 56 and the substantially elliptical wall 28 form an interference fit, thereby preventing rotation of the plant pot 14a about the axis A_{RA}. The flange 48 is configured to be seated upon the first tray side 18 by virtue of the downward gravitational force, and, when the self-orientating system 10 is assembled.

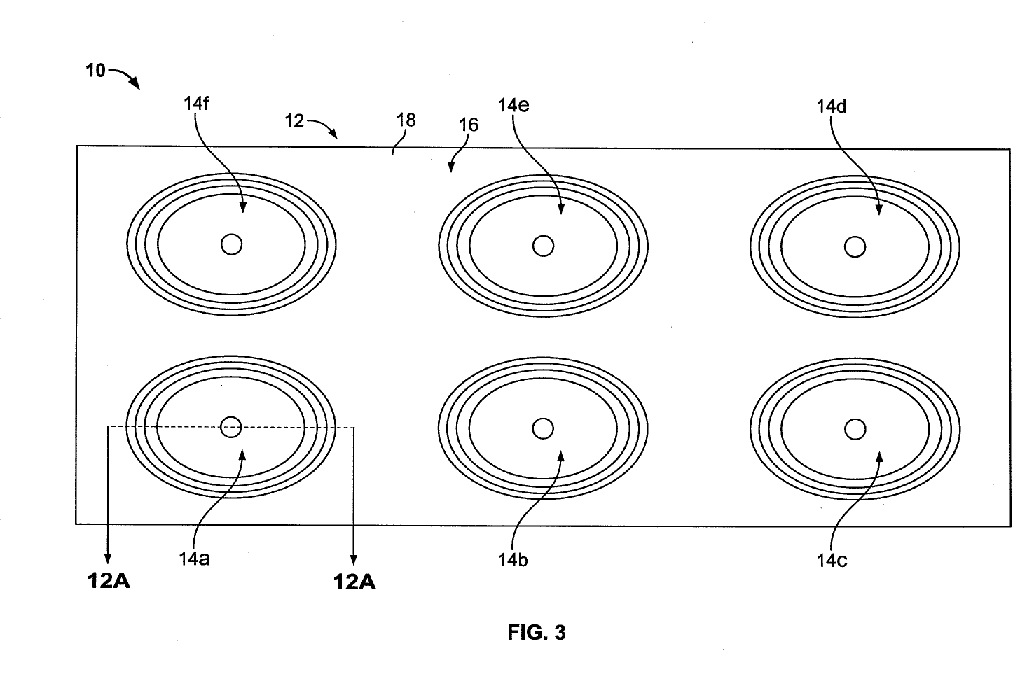

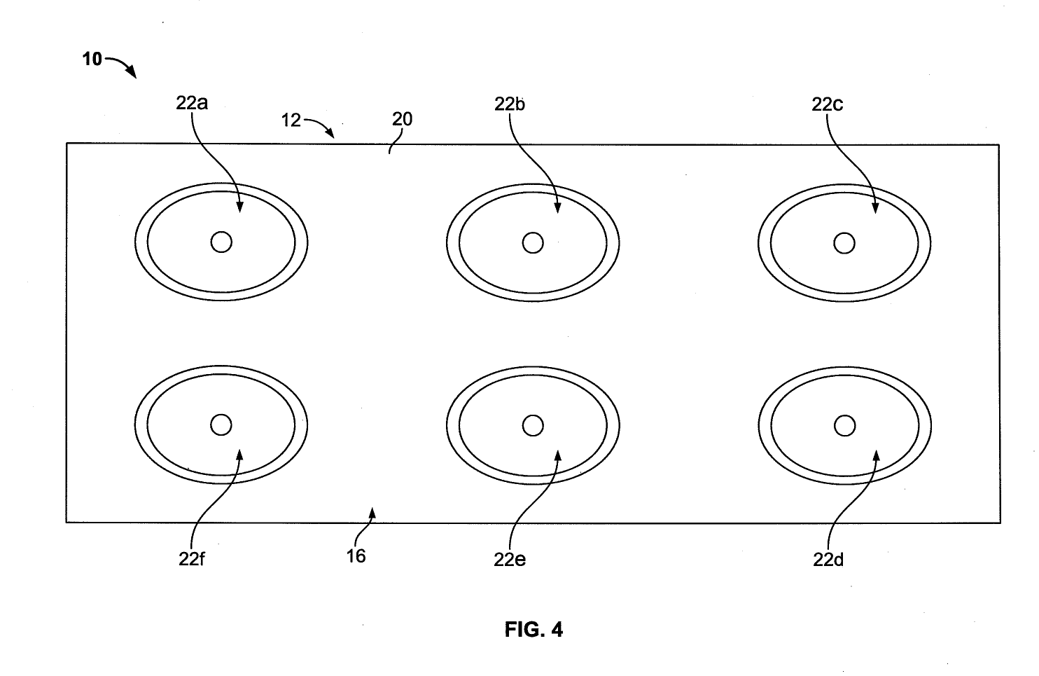

Referring to FIGS. 4 and 12A-15, the pot body 50 has an outer surface, referenced herein as a body outer surface 60, which is configured, such that, when the pot 14a is assembled with the tray 12, the body outer surface 60 faces the inner surface 40 of the receptacle 26. The pot body 50 preferably has a substantially elliptical cross-section and is sized, shaped, and dimensioned to mate with the body chamber 36. The substantially elliptical cross-section of the pot body 50 is preferably continuous along at least a part of an elevation of the pot body 50 (not designated), and, more preferably, along the entirety of the elevation of the pot body 50.

More particularly, the pot body 50 can be provided with a tapering substantially elliptical cross-section. For example, the cross-section along section line 14-14 of FIG. 5 (FIG. 14) is of a first area POT₁ and the cross-section along section line 15-15 of FIG. 5 (FIG. 15) is of a second area POT₂ less than the first area POT₁. Such tapering substantially elliptical cross-section is preferably continuous along at least a part of the elevation of the pot body 50, and, more preferably, along the entirety of the elevation of the pot body 50. In this regard, the pot body 50 preferably has a shape of a conventional frustum, but with a substantially-elliptical cross-section at the points along an elevation thereof. As shown, the pot body 50 is tapered in a direction opposite the top 46.

Similar to the above discussion concerning the receiving area 22a of the tray 12, the term “substantially elliptical cross-section,” when used to describe the plant pot 14a, should be construed as comprising a cross-section having any shape, so long as such shape includes curves not substantially forming a circle. The substantially elliptical cross-sections can include any suitable shape comprising, consisting, and/or consisting essentially of curves not substantially forming a circle, such that, when the self-orientating system 10 is assembled, the plant pot 14a is inhibited from rotation about the axis A_{RA} by virtue of an interference fit with the receiving area 22a.

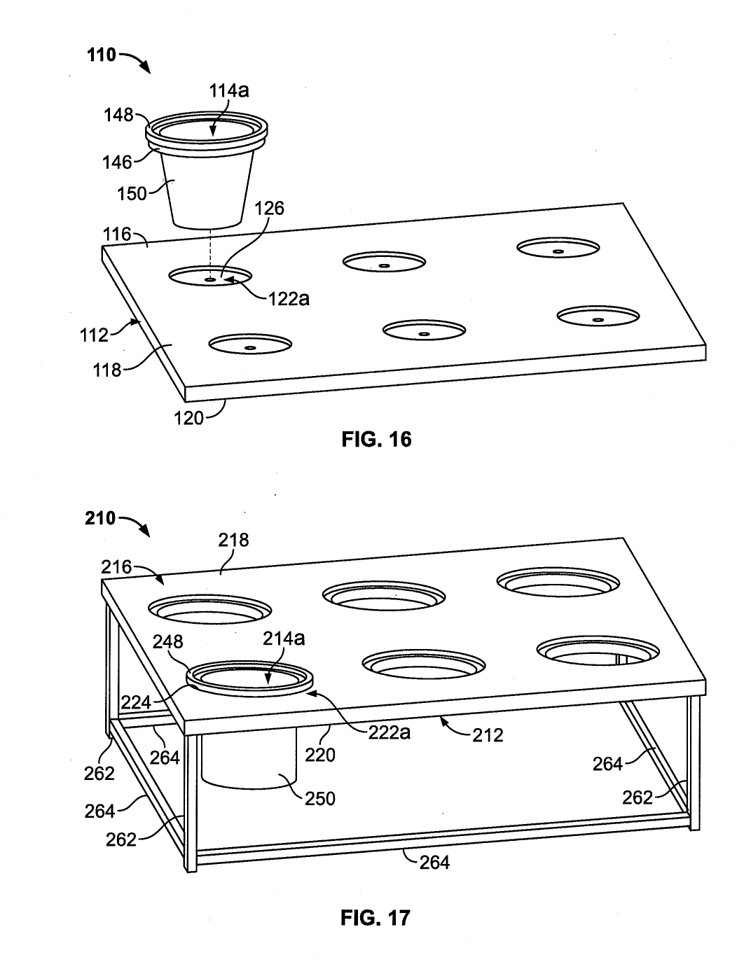

Referring to FIG. 16, a self-orientating system 110 is shown constructed in accordance with a second embodiment of the present invention. Elements illustrated in FIG. 16 which correspond substantially to the elements described above with reference to FIGS. 1-15 have been designated by corresponding reference numerals increased by one hundred. The embodiment of the present invention shown in FIG. 16 is constructed and used in manners consistent with the foregoing description of the self-orientating system 10 shown in FIGS. 1-15, unless it is stated otherwise.

Continuing with reference to FIG. 16, the self-orientating system 110 can be provided with a tray 112 having a tray body 116 and a plurality of receiving areas, such as receiving area 122a. A plurality of pots can be provided, such as the plant pot 114a shown, which has a top 146, a flange 148, and a pot body 150. The receiving area 122a includes a receptacle 126 that extends from a first tray side 118 partially toward a second tray side 120 to define a body chamber. The receptacle 126 (and the body chamber) of the receiving area 122a has a substantially elliptical cross-section, and the bottommost area of the plant body 150 has a substantially elliptical cross-section configured to mate with the body chamber of the receptacle 126 of the receiving area 122a. In this regard, the plant pot 114a is configured to sit atop the tray 112 and partially within the receptacle 126 of the receiving area 122a, so as to securingly align the plant pot 114a with respect to the tray 112. The top 146 and the flange 148 can have any suitable cross-section shape, including a circular cross-section.

Referring to FIG. 17, a self-orientating system 210 is shown constructed in accordance with a third embodiment of the present invention. Elements illustrated in FIG. 17 which correspond substantially to the elements described above with reference to FIGS. 1-15 have been designated by corresponding reference numerals increased by two hundred. The embodiment of the present invention shown in FIG. 17 is constructed and used in manners consistent with the foregoing description of the self-orientating system 10 shown in FIGS. 1-15, unless it is stated otherwise.

Continuing with reference to FIG. 17, the self-orientating system 210 can be provided with a tray 212 having a tray body 216 and a plurality of receiving areas, such as a receiving area 222a. The tray 212 is provided with a plurality of legs 262 for spacing the tray body 216 apart from an environmental surface upon which the legs 262 rest. To provide additional structural support, the tray 212 can be provided with braces 264 each extending from one of the legs 262 to another one of the legs 262 adjacent thereto. A plurality of pots can be provided, such as the plant pot 214a shown, which has a top 246, a flange 248, and a pot body 250. The receiving area 222a includes a depression 224 that extends between a first tray side 218 and a second tray side 220. The plant pot 214a is configured, such that the pot body 250 extends through and under the tray body 216, while the plant pot 214a is supported by the depression 224, which seats the top 248. The depression 224 of the receiving area 222a has a substantially elliptical cross-section, and the top 246 has a substantially elliptical cross-section configured to mate therewith so as to securingly align the plant pot 214a in a desired orientation. The pot body 250 can have any suitable cross-section shape, including a circular cross-section.

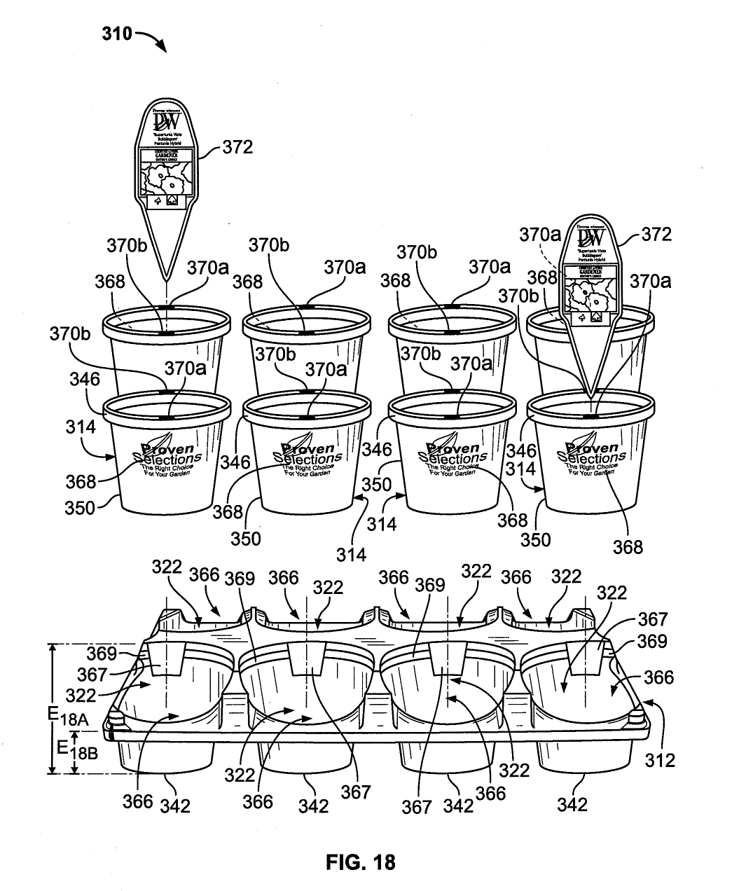

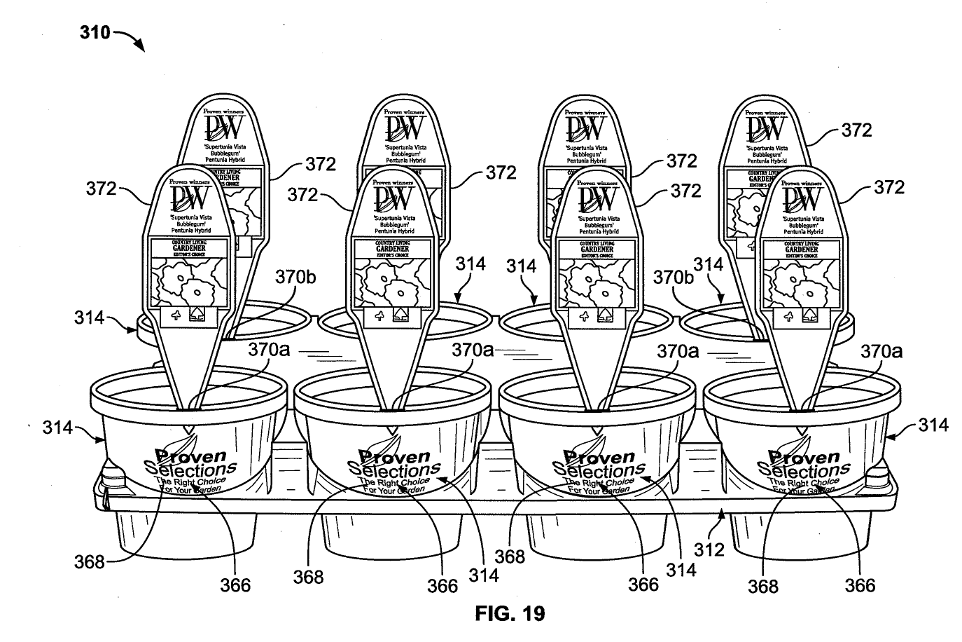

Referring to FIGS. 18 and 19, a self-orientating system 310 is shown constructed in accordance with another embodiment of the present invention. Elements illustrated in FIGS. 18 and 19 which correspond substantially to the elements described above with reference to FIGS. 1-15 have been designated by corresponding reference numerals increased by three hundred. The embodiment of the present invention shown in FIGS. 18 and 19 is constructed and used in manners consistent with the foregoing description of the self-orientating system 10 shown in FIGS. 1-15, unless it is stated otherwise.

Continuing with reference to FIGS. 18 and 19, the self-orientating system 310 can be provided with a tray 312 having a plurality of receiving areas 322. Each one of the receiving areas 322 is provided with a tray bottom surface 342 configured to support the tray 312 when rested upon an environmental structure, such as a solid shelf, for example.

Each one of the receiving areas 322 preferably has a substantially elliptical cross-section. As is shown in the embodiments of FIGS. 1-17, the embodiment of FIGS. 18-19 is shown with the major axis of each one of the receiving areas 322 facing substantially the same direction as the major axis of each other one of the receiving areas 322 and with the minor axis of each one of the receiving areas 322 facing substantially the same direction as the minor axis of each other one of the receiving areas 322.

Continuing with reference to FIGS. 18 and 19, each one of the receiving areas 322 is proximal a perimeter region of the tray 312 and includes an area of reduced height 366 to define a side opening in the tray 312. As shown in FIG. 18, for example, a central region of the tray 312 is provided with a first elevation E_{18A} and a perimeter region of the tray 312 is provided with a second elevation E_{18B} less than the first elevation E_{18A}. As shall be discussed with further detail below, the reduced height areas 366 enable indicia 368 on plant pots 314 to be viewed through the reduced height area 366.

A plurality of pots 314 can each be provided with a top 346 and a pot body 350 extending from the top 346. Each one of the plant pots 314 preferably has a substantially elliptical cross-section to interface with the receiving areas 322 to inhibit rotation of the plant pots 314. More preferably, each one of the tops 346 and/or each one of the bodies 350 can have substantially elliptical cross-sections to engage the receiving area 322.

The plant pots 314 may each have indicia 368 disposed thereon by any suitable method known in the art. Each indicia 368 can comprise text and/or a graphic, for example. The indicia 368 is preferably disposed on an outer side of the pot body 350 or on another visually-perceptible area of the plant pot 314. Each instance of indicia 368 can be the same as, or different from, each other instance of indicia 368 (e.g., same or different text or graphics). The location along the outside surface of the pots 314 at which the indicia 368 is disposed corresponds with the location along the outside of the receiving areas 322 at which the reduced height areas 366 are disposed in the tray 312. In this regard, when an elliptical pot 314 is received by an elliptical receiving area 322, the indicia 368 and the reduced height area 366 are aligned to enable viewing of the indicia 368 through the reduced height area 366 proximal the perimeter region. It is preferable that any one of the pots 314 can cooperate with any one of the receiving areas 322 to enable viewing of indicia 368 through any reduced height area 366. The indicia 368 is preferably printed (or otherwise disposed) on the wide sides of the pot 314, though it is contemplated that the indicia 368 can be disposed on the short sides of the pot 314.

As indicated above, FIG. 19 is front perspective view while a rear perspective view is substantially identical thereto. Thus, in the example of FIG. 19, for example, the indicia 368 of the front row of four pots face in a first direction (e.g., to the front), while the indicia 368 of the rear row of four ports face in a second direction opposite the first direction (e.g., to the rear).

Considering with reference to FIGS. 18 and 19, a plant tag may be positioned in a slot in the pots. For example, it is shown in FIGS. 18 and 19 that each of the plant pots 314 may include one or more slots 370 formed in the tops 346 for allowing plant tags 372 to be inserted therein along the wide side of the pot 314, for example. The plant tags 372 rest against the tops 346 of the pots 314 after insertion into the slots 370. The plant tags 372 are positioned to face in a uniform direction when the pots 314 are aligned within the receiving areas 322. This facilitates the ease at which the pots 314 can be placed into the tray 312, manually and/or by an automated process.

For example, in FIG. 19, the plant tags 372 associated with the front row of four pots 314 are shown proximal the perimeter region of the tray 312 and to face in the first direction, while the plant tags 372 of the second row of four pots 314 are also shown to face in the first direction, and are proximal the central region of the tray 312. The plant tags 372 can be side-by-side and/or behind one another. More specifically, while the plant tags 372 do preferably face in the same direction (e.g., as shown in FIG. 19), a plant tag 372 can be positioned to at least partially flank a first plant tag (such as plant tags that are both somewhere in the front row or proximal thereto), and/or a plant tag can be positioned at least partially behind the first plant tag (such as a plant tag in the front row and a plant tag in the rear row).

Continuing with further discussion of those plant tags 372 positioned proximal the central region of the tray 312, the top portion of the receiving areas 322 can include a shoulder 369 upon which a corresponding shoulder of the pot 314 can rest, and bevels 367 can be provided therewith for providing further room to accommodate one or more plant tags 372.

In some embodiments, the plant tags 372 associated with the front row of four pots 314 are proximal the perimeter region of the tray 312 and face in the first direction (as shown in FIG. 19), while the plant tags 372 of the second row of four pots 314 are also placed proximal the perimeter region to face in a second direction opposite the first direction.

It shall be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A self-orientating plant pot and tray system comprising:
a first plant pot having a first drain opening and a first substantially elliptical cross-section at least partially defining a first side as one of a wide side and a short side;
a tray including a first receiving area having a second substantially elliptical cross-section corresponding to said first substantially elliptical cross-section to align said first side to be outwardly facing with respect to an outer perimeter of said tray and to face in a first direction; and
a second plant pot having a second drain opening and a third substantially elliptical cross-section at least partially defining a second side as said one of a wide side and a short side;
wherein said tray further includes a second receiving area having a fourth substantially elliptical cross-section corresponding to said third substantially elliptical cross-section to align said second side to be outwardly facing with respect to an outer perimeter of said tray and to face in said first direction.

2. The system of claim 1, wherein said first receiving area is provided with a drain opening for fluid communication with said first drain opening.

3. The system of claim 1, wherein said first receiving area has a major axis and a minor axis in respective alignment with a major axis and a minor axis of said second receiving area.

4. The system of claim 1, wherein said first side is provided with first indicia.

5. The system of claim 4, wherein said first indicia comprises at least one of text and a graphic.

6. The system of claim 4, wherein said tray includes a first reduced height area.

7. The system of claim 6, wherein said tray includes a central region having a first elevation, and a perimeter region having a second elevation less than said first elevation, and wherein said first reduced height area is proximal said perimeter region.

8. The system of claim 6, wherein said tray is configured to align said first reduced height area with said first indicia for viewing thereof.

9. The system of claim 8, wherein said second side is provided with second indicia, wherein said tray includes a second reduced height area, and wherein said tray is configured to align said second reduced height area with said second indicia for viewing thereof such that said first and second indicia both face in said first direction.

10. The system of claim 9, comprising:
a third plant pot having a third drain opening and a fifth substantially elliptical cross-section at least partially defining a third side as said one of a wide side and a short side;
wherein said tray further includes a third receiving area having a sixth substantially elliptical cross-section corresponding to said fifth substantially elliptical cross-section to align said third side to be outwardly facing with respect to an outer perimeter of said tray and to face in a second direction opposite said first direction.

11. The system of claim 10, wherein said third side is provided with third indicia, wherein said tray includes a third reduced height area, and wherein said tray is configured to align said third reduced height area with said third indicia for viewing thereof such that said third indicia faces in said second direction opposite said first and second indicia.

12. A self-orientating plant pot and tray system comprising:
a first plant pot having a first drain opening and a first substantially elliptical cross-section;
a first plant tag configured to be arranged with said first plant pot;
a tray including a first receiving area having a second substantially elliptical cross-section corresponding to said first substantially elliptical cross-section to align said first plant pot to face said first plant tag in a first direction;
a second plant pot having a second drain opening and a third substantially elliptical cross-section; and
a second plant tag configured to be arranged with said second plant pot;
wherein said tray further includes a second receiving area having a fourth substantially elliptical cross-section corresponding to said third substantially elliptical cross-section to align said second plant pot to face said second plant tag in said first direction.

13. The system of claim 12, wherein said first receiving area has a major axis and a minor axis in respective alignment with a major axis and a minor axis of said second receiving area.

14. The system of claim 12, wherein said first receiving area is provided with a drain opening for fluid communication with said first drain opening.

15. The system of claim 12, wherein said first plant pot has a first slot configured to receive said first plant tag.

16. The system of claim 15, wherein said first substantially elliptical cross-section of said first plant pot at least partially defines a first side configured to face said first direction.

17. The system of claim 16, wherein said first slot is aligned with said first side.

18. The system of claim 17, wherein said second plant pot has second slot configured to receive said second plant tag, wherein said third substantially elliptical cross-section of said second plant pot at least partially defines a second side configured to face said first direction, and wherein said second slot is aligned with said second side.

19. The system of claim 18, wherein said tray includes a central region and a perimeter region.

20. The system of claim 19, wherein said first plant pot is configured to be arranged with said first side proximal said perimeter region, and wherein said second plant pot is configured to be arranged with said second side proximal said perimeter region, such that said second plant tag at least partially flanks said first plant tag.

21. The system of claim 19, wherein said first plant pot is configured to be arranged with said first side proximal said perimeter region, and wherein said second plant pot is configured to be arranged with said second side proximal said central region, such that said second plant tag is at least partially behind said first plant tag.

22. The system of claim 21, wherein said second receiving area is provided with a beveled shoulder configured to receive said second plant tag.

23. A self-orientating plant pot and tray system comprising:
a first plant pot having a first substantially elliptical cross-section and first indicia disposed along a first side at least partially defined thereby;
a first plant tag configured to be arranged with said first plant pot;
a tray having a first receiving area and a first reduced height area, said first receiving area having a second substantially elliptical cross-section corresponding to said first substantially elliptical cross-section, wherein said tray is configured to align said first reduced height area with said first indicia for viewing thereof and to align said first plant pot to face said first plant tag in a first direction;
a second plant pot having a third substantially elliptical cross-section and second indicia disposed along a second side at least partially defined thereby; and
a second plant tag configured to be arranged with said second plant pot;
wherein said tray further includes a second receiving area and a second reduced height area, said second receiving area having a fourth substantially elliptical cross-section corresponding to said third substantially elliptical cross-section, wherein said tray is configured to align said second reduced height area with said second indicia for viewing thereof and to align said second plant pot to face said second plant tag in said first direction.

24. The system of claim 23, wherein said tray includes a central region and a perimeter region, wherein said first plant pot is configured to be arranged with said first side proximal said perimeter region, and wherein said second plant pot is configured to be arranged with said second side proximal said perimeter region, such that said second plant tag at least partially flanks said first plant tag.

25. The system of claim 23, wherein said tray includes a central region and a perimeter region, wherein said first plant pot is configured to be arranged with said first side proximal said perimeter region, and wherein said second plant pot is configured to be arranged with said second side proximal said central region, such that said second plant tag is at least partially behind said first plant tag.
